(19) United States
(12) Patent Application Publication
(10) Pub. No.: US 2025/0278219 A1
(43) Pub. Date: Sep. 4, 2025

(54) IMAGE FORMING SYSTEM, OPERATION RECEPTION APPARATUS, AND NON-TRANSITORY COMPUTER READABLE MEDIUM STORING PROGRAM

(71) Applicant: FUJIFILM Business Innovation Corp., Tokyo (JP)

(72) Inventor: Mitsuhiro FUKUSHIMA, Kanagawa (JP)

(73) Assignee: FUJIFILM Business Innovation Corp., Tokyo (JP)

(21) Appl. No.: 18/786,575

(22) Filed: Jul. 29, 2024

(30) Foreign Application Priority Data
Mar. 1, 2024 (JP) 2024-031533

(51) Int. Cl. G06F 3/12

(52) U.S. Cl. CPC G06F 3/1208

(57) ABSTRACT

An image forming system includes one or more processors configured to have a mode of executing a process of printing a print image using a special color with respect to a special color gamut of an object image, which is selected by a user, of a preview screen of the print image.

### CROSS-REFERENCE TO RELATED APPLICATIONS

This application is based on and claims priority under 35 USC 119 from Japanese Patent Application No. 2024-031533 filed Mar. 1, 2024.

### BACKGROUND

### (i) Technical Field

The present invention relates to an image forming system, an operation reception apparatus, and a non-transitory computer readable medium storing a program.

### (ii) Related Art

JP2016-103695A discloses a technique related to an image forming system including an information processing apparatus that has image data represented by a normal color, and an image forming apparatus that forms an image using a specific color different from the normal color in addition to the normal color. In the related art, the image forming system includes a substitution color designation unit that designates a substitution color from the normal color, a specific color association unit that associates a specific color with the substitution color, a specific color substitution unit that substitutes the substitution color included in the image data with the specific color associated by the specific color association unit, and an image forming unit that forms an image based on the image data by the normal color and the specific color.

JP2020-149220A discloses a technique relating to an information processing apparatus including a control unit that controls a printing apparatus and a processing unit that performs a preview of printing. In the related art, the processing unit displays a preview screen, acquires information on a range in which white printing is performed in accordance with an operation of a user via the preview screen, generates drawing designation based on the information, and transmits the drawing designation to the control unit, and, in a case where the range related to the white printing indicated by the drawing designation is included in a range indicated by held range information, the control unit generates print data of a white drawing object and print data corresponding to the drawing designation and transmits the print data to the printing apparatus.

### SUMMARY

In a case where an object of a rectangular area, which is set by a user, of a preview screen of a print image is printed using a special color, for example, in a case where there are two object images in the rectangular area, both object images are printed using the special color, and only one object image cannot be printed using the special color.

Aspects of non-limiting embodiments of the present disclosure relate to an image forming system, an operation reception apparatus, and a non-transitory computer readable medium storing a program that individually select and print an object image to be printed using a special color.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming system including one or more processors configured to have a mode of executing a process of printing a print image using a special color with respect to a special color gamut of an object image, which is selected by a user, of a preview screen of the print image.

### BRIEF DESCRIPTION OF THE DRAWINGS

Exemplary embodiment(s) of the present invention will be described in detail based on the following figures, wherein:

FIG. 1 is a schematic configuration diagram of an image forming system according to an exemplary embodiment of the present invention;

FIG. 2 is a schematic block diagram of a hardware configuration of an image processing apparatus according to the exemplary embodiment of the present invention;

FIG. 3 is a schematic block diagram of a functional configuration of the image processing apparatus according to the exemplary embodiment of the present invention;

FIG. 4 is a schematic block diagram of a hardware configuration of an image forming apparatus according to the exemplary embodiment of the present invention;

FIG. 5 is an explanatory diagram showing a configuration of an example of a print engine of the image forming apparatus according to the exemplary embodiment of the present invention;

FIG. 6 is a schematic block diagram of a functional configuration of the image forming apparatus according to the exemplary embodiment of the present invention;

FIG. 7 is an example of a UI screen of a liquid crystal display of the image forming apparatus according to the exemplary embodiment of the present invention;

FIG. 8 is an example of a print image of a preview screen of the UI screen of the liquid crystal display of FIG. 7;

FIG. 9 is a diagram of a state in which a rectangular frame is set for the print image of the preview screen of FIG. 8;

FIG. 10 is a diagram of a state in which a background color and the rectangular frame are set for the print image of the preview screen of FIG. 8;

FIG. 11 is a diagram of a state in which a rectangular area surrounded by the rectangular frame of the print image of the preview screen of FIG. 10 is enlarged and a free curve is set;

FIG. 12 is a diagram of a state in which a range, in which a rectangular area of FIG. 11 is enlarged and a free curve is set, is divided into micro rectangular areas; and

FIG. 13 is a flowchart showing an example of a process in a case where a background color and a first color gamut are the same color.

### DETAILED DESCRIPTION

### Exemplary Embodiment

An exemplary embodiment of an image forming system will be described. In each drawing, the identical or equivalent components, portions, and the like are denoted by the identical reference numerals, and overlapping description will be omitted or simplified. In addition, a dimensional ratio in the drawing is exaggerated for convenience of description and may differ from an actual ratio.

### Overall Configuration

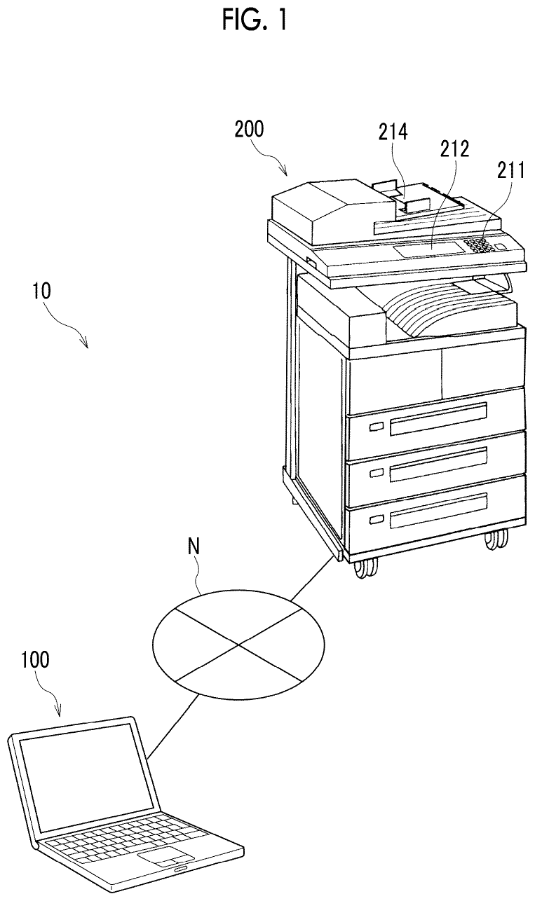

FIG. 1 is a diagram showing a schematic configuration of an image forming system 10 according to the present exemplary embodiment.

As shown in FIG. 1, an image forming system 10 is configured by connecting an image processing apparatus 100 and an image forming apparatus 200 to a communication unit such as a network N. As the communication unit, various networks such as a Local Area Network (LAN), a Wide Area Network (WAN), the Internet, an intranet, and Ethernet (registered trademark), can be applied as will be described later.

In addition, FIG. 1 shows an example in which one image processing apparatus 100 and one image forming apparatus 200 are provided, but the number of apparatuses is not limited thereto. Here, in the present exemplary embodiment, the image processing apparatus 100 is a Personal Computer (PC). In addition, the image forming apparatus 200 is an apparatus having various functions such as a print function. The image forming apparatus 200 according to the present exemplary embodiment is a so-called multifunction peripheral having a copy function, a facsimile function, a scanner function, and the like in addition to the print function, but the present disclosure is not limited thereto.

### Image Processing Apparatus

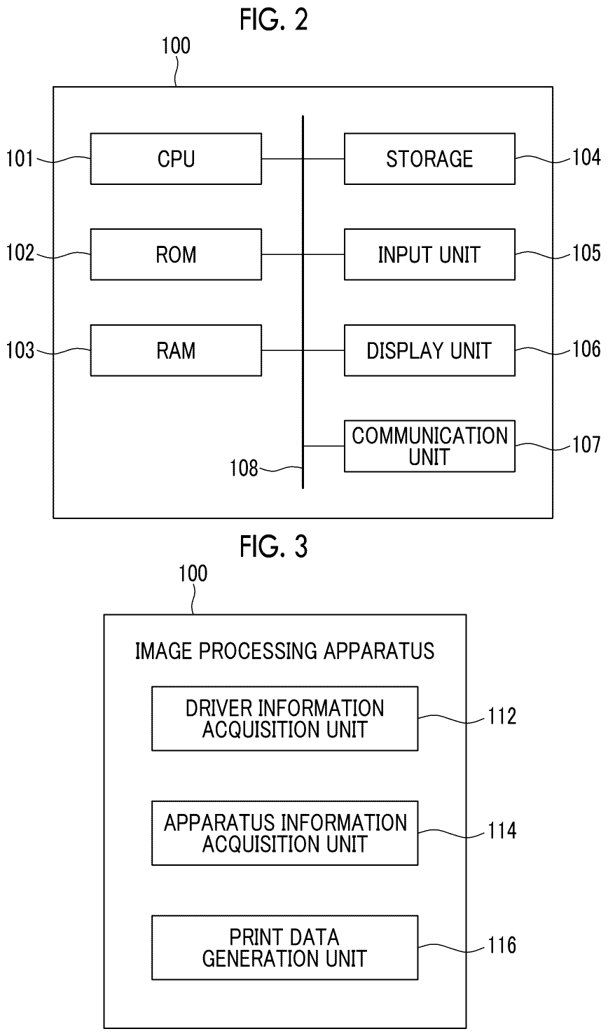

FIG. 2 is a block diagram showing a hardware configuration of the image processing apparatus 100 according to the present exemplary embodiment.

As shown in FIG. 2, the image processing apparatus 100 includes a Central Processing Unit (CPU) 101 that is an example of a processor, a Read Only Memory (ROM) 102, a Random Access Memory (RAM) 103, a storage 104, an input unit 105, a display unit 106, and a communication unit 107. Each configuration is connected to each other via a bus 108 so as to be communicable with each other.

The CPU 101 is a central calculation processing unit, executes various programs, and controls each unit. That is, the CPU 101 reads a program from the ROM 102 or the storage 104, and executes the program using the RAM 103 as a working area. The CPU 101 controls each configuration and performs various kinds of calculation processing according to the program recorded in the ROM 102 or the storage 104. In the present exemplary embodiment, the program is stored in the ROM 102 or the storage 104.

The ROM 102 stores various types of programs and various types of data. The RAM 103 temporarily stores the program or data as a working area. The storage 104 is configured of a Hard Disk Drive (HDD) or a Solid State Drive (SSD), and stores various programs including an operating system and various types of data.

The input unit 105 includes a pointing device such as a mouse, and a keyboard, and is used for performing various inputs.

The display unit 106 is a liquid crystal display, for example. The display unit 106 displays various kinds of information on the basis of the control of the CPU 101. The display unit 106 may employ a touch panel system to function as the input unit 105.

The communication unit 107 is used to communicate with the image forming apparatus 200 or other apparatuses such as a server apparatus (not shown), and, for example, a standard, such as a LAN, a public line, the Internet, an intranet, Ethernet (registered trademark), FDDI, or Wi-Fi (registered trademark), is used.

FIG. 3 is a block diagram showing a functional configuration of the image processing apparatus 100.

As shown in FIG. 3, the image processing apparatus 100 is configured to include a driver information acquisition unit 112, an apparatus information acquisition unit 114, and a print data generation unit 116.

The driver information acquisition unit 112 acquires and holds various information of the printer driver. The various information is information, which is set in a user interface of a printer driver, or the like. The apparatus information acquisition unit 114 acquires the apparatus information of the image forming apparatus 200 (see FIG. 1) via a network N (see FIG. 1). The apparatus information is, for example, color information of each color toner of the image forming apparatus 200 described below. The print data generation unit 116 generates print data to be transmitted to the image forming apparatus 200 (see FIG. 1) instructed by the user by operating a print application.

### Image Forming Apparatus

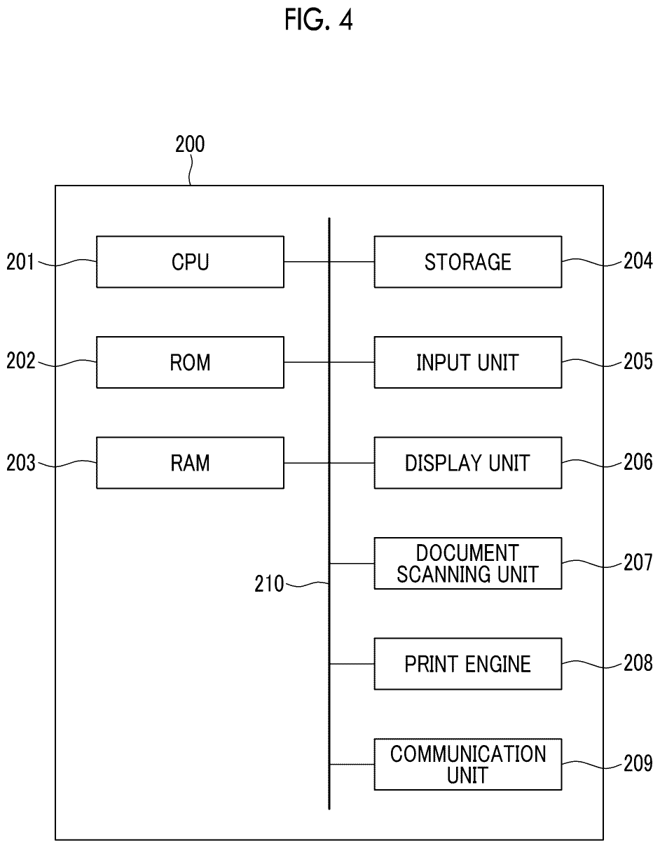

FIG. 4 is a block diagram showing a hardware configuration of the image forming apparatus 200 according to the present exemplary embodiment.

As illustrated in FIG. 4, the image forming apparatus 200 has a Central Processing Unit (CPU) 201 that is an example of a processor, a Read Only Memory (ROM) 202, a Random Access Memory (RAM) 203, a storage 204, an input unit 205, a display unit 206, a document scanning unit 207, a print engine 208, and a communication unit 209. These configurations are communicably connected to each other via a bus 210.

The CPU 201 is a central calculation processing unit and executes various programs or controls each unit. That is, the CPU 201 reads a program from the ROM 202 or from the storage 204 and executes the program using the RAM 203 as a working area. The CPU 201 performs control of each of the above configurations and various calculation processing in accordance with the program recorded in the ROM 202 or in the storage 204. In the present exemplary embodiment, the program is stored in the ROM 202 or the storage 204.

The ROM 202 stores various programs and various data. The RAM 203 temporarily stores a program or data as the working area. The storage 204 is configured of a hard disk drive (HDD) or a solid state drive (SSD), and stores various programs including an operating system and various types of data.

The input unit 205 is configured to include various buttons 211 (see FIG. 1), such as a start button and numeric keys, a touch panel system liquid crystal display 212 (see FIG. 1), and the like. The input unit 205 functions as a User Interface (UI) that receives an operation of the user and displays various information to the user, based on a control of the CPU 201.

In addition, the display unit 206 is the above-described liquid crystal display 212 (see FIG. 1). The display unit 206 displays various information on the basis of the control of the CPU 201. In addition, since the display unit 206 according to the present exemplary embodiment employs the touch panel system as described above, thereby also functioning as the input unit 205. The liquid crystal display 212 (refer to FIG. 1) is an example of an operation reception apparatus.

The document scanning unit 207 takes the document placed on the paper feeding tray 214 (see FIG. 1) of an automatic feeding apparatus provided on the upper portion of the image forming apparatus 200 one by one, optically scans the taken-in document to obtain image information, and optically scans the document placed on a platen glass to obtain the image information.

The print engine 208 forms, that is, prints an image, which is created based on the print data obtained from the image processing apparatus 100 (see FIG. 1) and the print data obtained by scanning by the document scanning unit 207 of the image forming apparatus 200, on a recording medium such as paper.

The communication unit 209 is used to communicate with the image processing apparatus 100 (see FIG. 1) and other apparatuses, such as a server apparatus (not shown), and, for example, a standard, such as a LAN, a public line, the Internet, an intranet, Ethernet (registered trademark), FDDI, or Wi-Fi (registered trademark), is used.

In addition, the communication unit 209 connects the image forming apparatus 200 to a public line, and transmits and receives the image information obtained by scanning by the document scanning unit 207 to and from another image forming apparatus having a facsimile (FAX) function.

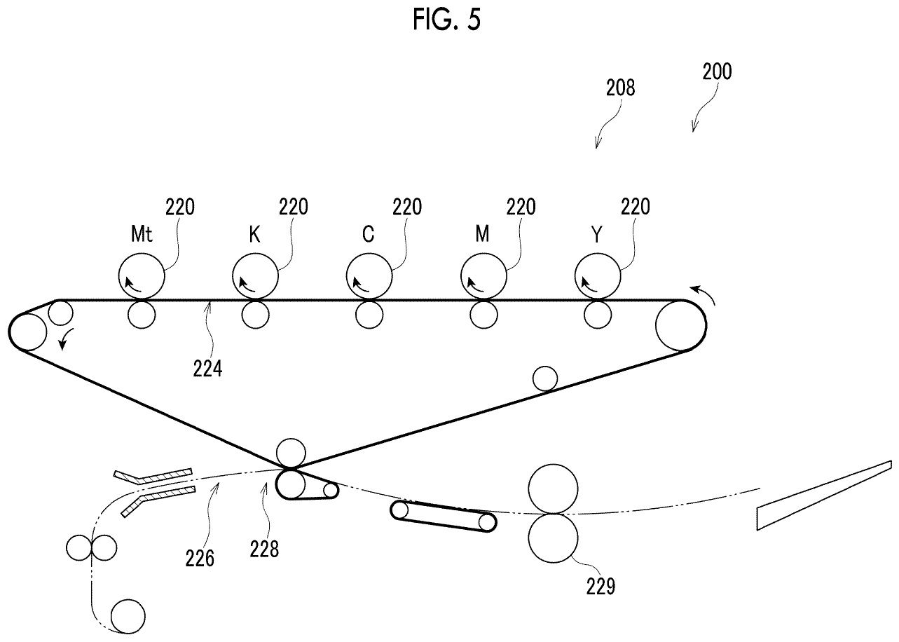

FIG. 5 schematically shows a configuration of an example of the print engine 208 provided in the image forming apparatus 200 according to the present exemplary embodiment. The print engine 208 is an electrophotographic type full-color print engine of an intermediate transfer system, and uses toners of respective colors as color materials. In addition, the print engine 208 has a tandem-type photosensitive body disposition configuration. This photosensitive body disposition configuration has a photosensitive body 220 for a CMYK toner consisting of C (cyan), M (magenta), Y (yellow), and K (black), and a photosensitive body 220 for a silver toner (Si) Mt as an example of a special color toner for printing a special color, and the photosensitive body 220 for a silver toner (Si) Mt is disposed on a downstream side of the photosensitive body 220 for a CMYK toner.

Here, the silver toner (Si) Mt is one of the metallic toners for adding a metallic feeling, and examples of the metallic toner other than the silver toner include a golden gold toner (G). In addition, the metallic feeling refers to a metallic glossiness of light, and is a general term for a metallic glossiness due to regular reflection of light on a smooth metal surface and a sparkle feeling that shows a feeling of shining brilliantly in accordance with a change in a direction of incident light due to a collection of micro cut surfaces or metal flakes of metal facing in various directions.

In the example of FIG. 5, the toner image formed on each of the photosensitive bodies 220 is primarily transferred onto the intermediate transfer belt 224 in the order of Y, M, C, K, and Mt from the upstream side to the downstream side along a traveling direction of the intermediate transfer belt 224. Accordingly, a full color toner image including layers of each toner is formed on the intermediate transfer belt 224. The full color toner image is secondarily transferred onto a printing medium, for example, a sheet-shaped paper transported by the medium transport system 226 in the secondary transfer portion 228. As a result, the full color toner image is formed on the surface of the printing medium, and this full color toner image is fixed to the printing medium by the fixing portion 229.

In the example of FIG. 5, the disposition order of the photosensitive bodies 220 for a CMYK toner, which is in order of Y, M, C, and K from the upstream side, is merely an example. In addition, the disposition of the photosensitive body 220 for silver toner (Si) Mt upstream the photosensitive bodies 220 of Y, M, C, and K is not excluded.

The image processing apparatus 100 realizes various functions by using the hardware resources. A functional configuration realized by the image processing apparatus 100 will be described.

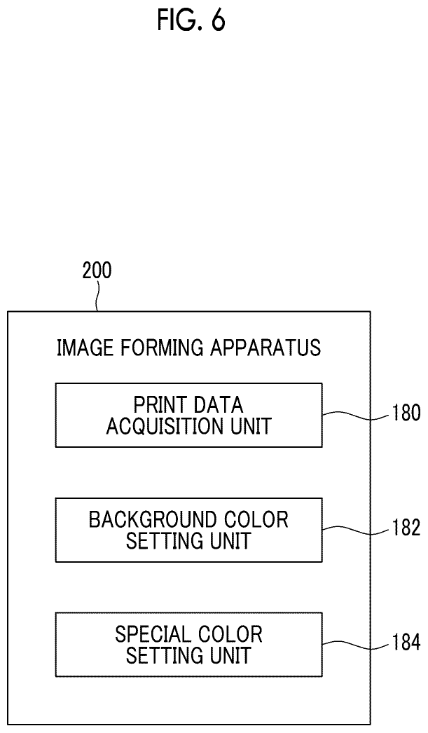

FIG. 6 is a block diagram showing an example of the functional configuration of the image forming apparatus 200.

As shown in FIG. 6, the image forming apparatus 200 has a print data acquisition unit 180, a background color setting unit 182, and a special color setting unit 184 as a functional configuration.

The print data acquisition unit 180 acquires the print data generated by the image processing apparatus 100 (see FIG. 1), the scanning data scanned by the document scanning unit 207 (see FIG. 4), and the like. The background color setting unit 182 sets a background color on each page. The “background color” is a color set as a color of the base on each page. In a page to which the background color is not set, the background color is not printed. The special color setting unit 184 sets a special color gamut to be converted into a special color and an object image to be converted into a special color on each page. The special color in the present exemplary embodiment is silver as described above. In addition, the object image is a general term for a figure, an image, or the like other than a character such as a text and a number.

### Flow of Print Process

Next, a flow of a process of performing special color printing using a special color will be described. The flow and the print image are examples and are not limited thereto.

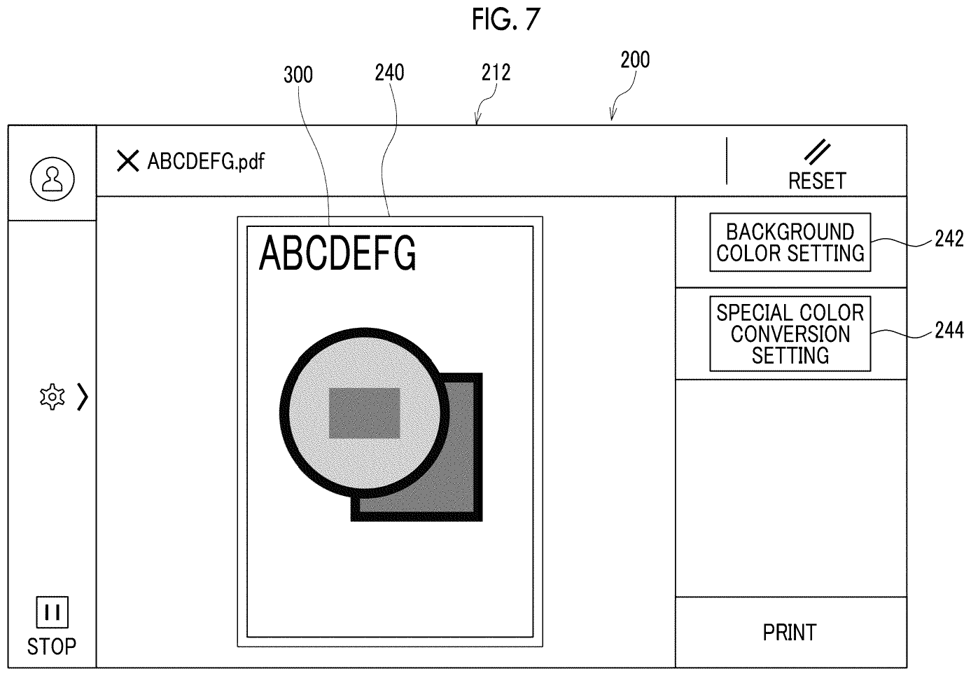

FIG. 7 is an example of a user interface (hereinafter, there is a case of being referred to as “UI”) of the liquid crystal display 212 (see FIG. 1) of the image forming apparatus 200. A so-called preview screen 240, which is a prior confirmation screen for prior confirmation of the print image of each page, is displayed on the liquid crystal display 212. On the preview screen 240 in FIG. 7, a preview image 300 of a print image before the background color and the special color are set is displayed.

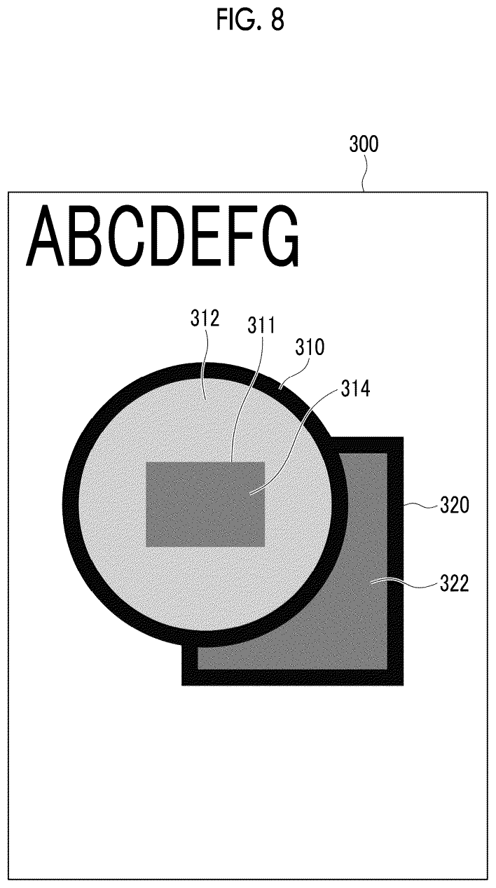

As shown in FIG. 8, in the preview image 300 of the print image, a text “ABCDEFG” is present on the left side of the upper end portion, and a first object image 310 and a second object image 320 are present in the central portion. The first object image 310 has a circular shape and has a lower right portion superimposed on an upper left corner portion of the second object image 320 having a square shape.

The first object image 310 and the second object image 320 are filled with different colors, respectively. Further, a square portion 311 at the central portion of the first object image 310 has a color different from the others. In the present exemplary embodiment, in the preview image 300, a part of the circular first object image 310 excluding the square portion 311 at the center is set as a first color gamut 312, the square portion 311 at the center is set as a second color gamut 314, and the second object image 320 is set as a third color gamut 322.

In the present example, with respect to the preview image 300, a case where only the first color gamut 312 of the circular first object image 310 excluding the square portion 311 at the center is converted into a special color and is printed will be described as an example. The first color gamut 312 is an example of a special color gamut. In addition, the special color in the present exemplary embodiment is silver.

First, a case where the background color is not set will be described.

The user presses a tab 244 (see FIG. 7) of “special color conversion setting” of the touch panel type liquid crystal display 212 (see FIGS. 1 and 7) and then surrounds and sets an object to be converted into the special color.

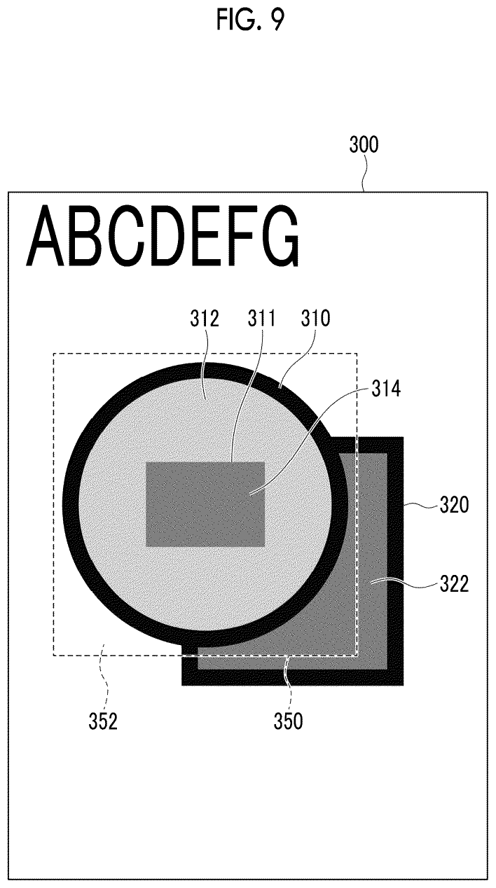

Specifically, as shown in FIG. 9, the user surrounds the circular first object image 310 with a rectangular frame 350 in the preview image 300 displayed on the preview screen 240 (see FIG. 7). The rectangular frame 350 is formed by the user's fingertip, or a pen such as a stylus pen or a touch pen. An area surrounded by the rectangular frame 350 is referred to as a rectangular area 352.

In a case where a plurality of color gamuts are present in the rectangular area 352 surrounded by the rectangular frame 350 as in the present example, the user designates a color gamut to be converted into a special color among the plurality of color gamuts. In the present example, the first color gamut 312 of the circular first object image 310 excluding the square portion 311 at the center is designated. A designation method may be any method. For example, the first color gamut 312, the second color gamut 314, and the third color gamut 322 are blinked, and setting is made by touching the first color gamut 312 with a fingertip or a pen by the user. A plurality of color gamuts may be set. After the designation, the user gives a printing instruction, so that the first color gamut 312 of the first object image 310 in the preview image 300 is converted into the special color and printed. Alternatively, the colorimetric value of the first color gamut 312 to be converted into the special color may be set by numerical input.

Next, a case of setting the background color will be described.

The user presses a tab 242 (see FIG. 7) of “background color setting” of the touch panel type liquid crystal display 212 (see FIGS. 1 and 7) and then designates a color of a background color 308 (see FIG. 9). The background color 308 of the present example is the same color as the first color gamut 312 (see FIG. 8).

Next, the user presses the tab 244 (refer to FIG. 7) of “special color conversion setting” and then sets conversion of the first color gamut 312 of the circular first object image 310 excluding the square portion 311 at the center into the special color.

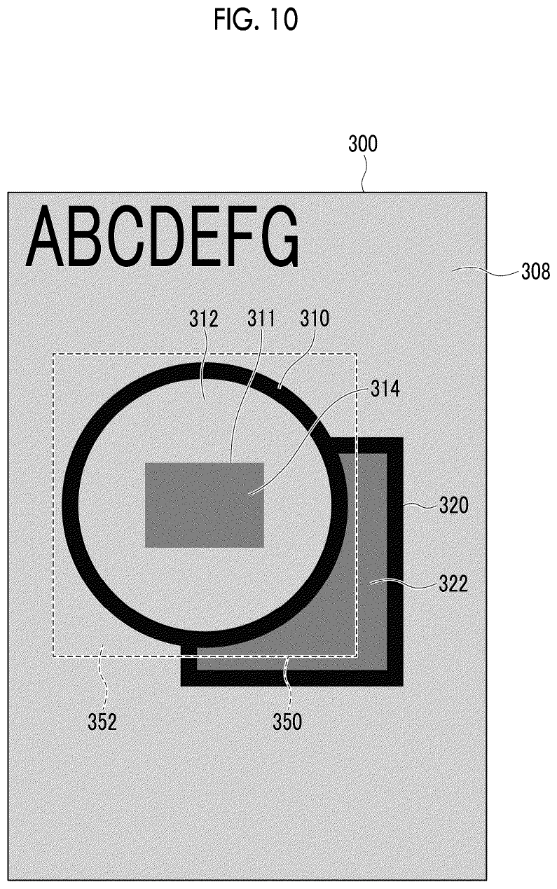

FIG. 10 is a diagram showing a state in which the first object image 310 of the preview image 300 in which the background color 308 is set is surrounded by the rectangular frame 350. As described above, the background color 308 and the first color gamut 312 of the first object image 310 are the same color. Accordingly, a message indicating whether or not to set an area to be converted into the special color with a free curve is displayed on the liquid crystal display 212 (refer to FIG. 1 and FIG. 7), for example, “The first color gamut 312 of the selected first object image 310 is the same as the background color. Do you want to set the area to be converted with a free curve in detail?” is displayed.

In a case where the user selects “do not set with a free curve”, the background color 308 and the first color gamut 312 in the rectangular area 352 of the rectangular frame 350 are converted into special colors and printed.

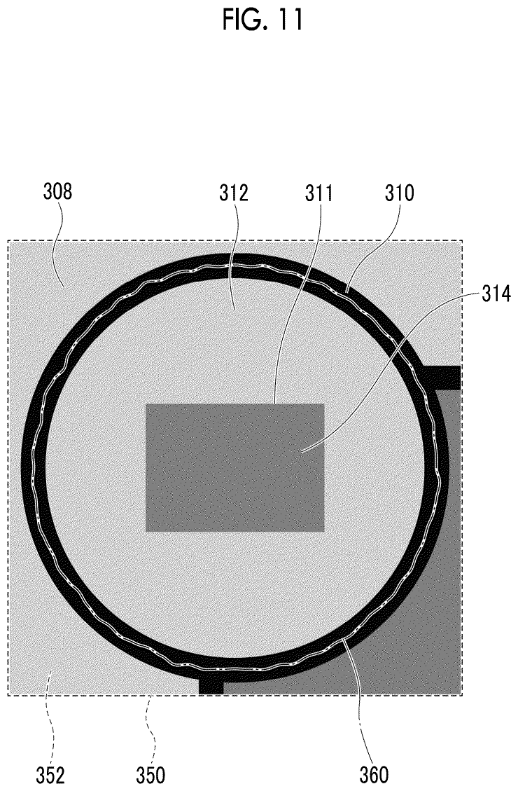

In a case where the user selects “set with a free curve”, as shown in FIG. 11, the rectangular frame 350 (rectangular area 352) is enlarged and displayed on the preview screen 240 (see FIG. 7), and the user surrounds the outer shape of the first object image 310 with a free curve 360. Accordingly, only the first color gamut 312 of the first object image 310 surrounded by the free curve 360 is selected.

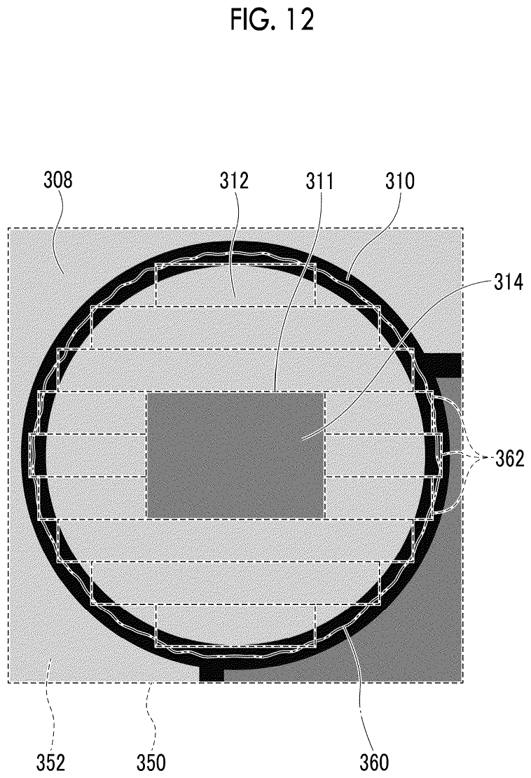

In the present exemplary embodiment, as shown in FIG. 12, the first color gamut 312 of the first object image 310 surrounded by the free curve 360 is divided into small micro rectangular areas 362 and converted into special colors, respectively, and the background color 308 is separated by a set of the micro rectangular areas 362 converted into the special colors. The “micro rectangular area” is an area obtained by finely dividing the object image in which the special color is designated, and is specifically a rectangular block in which the special color is designated. From another viewpoint, the “micro rectangular area” is a micro area of a rectangle used for numerical integration by a rectangular approximation method.

The micro rectangular area 362 in FIG. 12 is larger than the actual size for ease of understanding of the description. In addition, the micro rectangular area 362 may be displayed on the preview screen 240 (refer to FIG. 7) or may not be displayed only in an internal process.

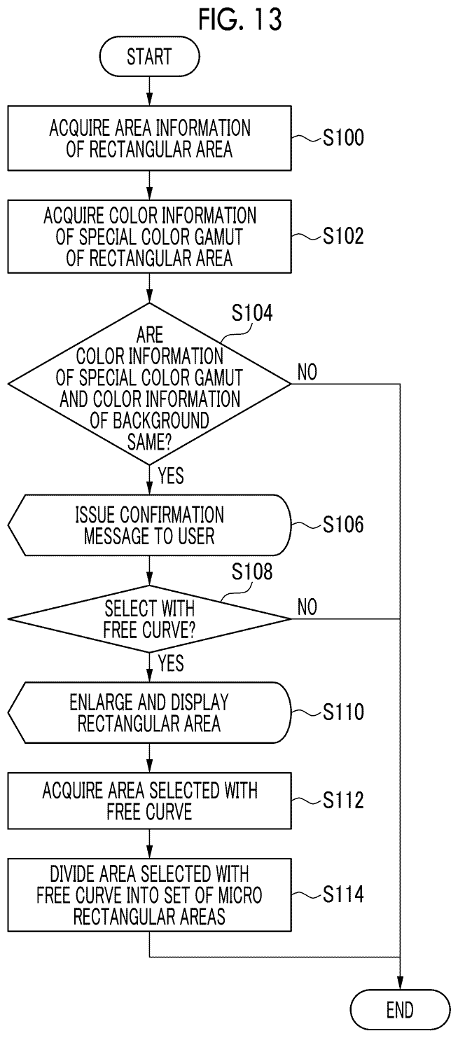

Next, a flow of a selection process of the object image to be printed with the special color in a case where the background color 308 and the first color gamut 312 are the same color will be described by using a flowchart of FIG. 13. The process is performed in such a way that the CPU 201 (see FIG. 4) reads the program stored in the ROM 202 or the storage 204 (see FIG. 4) and develops and executes the program in the RAM 203 (see FIG. 4).

As shown in FIG. 13, in step S100, the CPU 201 acquires area information of a rectangular area surrounded by a rectangular frame (see a rectangular area 352 in FIG. 10). The “area information” is image information designated by a rectangular frame in the image of the page area, and specifically, is image information consisting of a bitmap image, such as BMP, GIF, JPEG, PNG, and TIFF, of the rectangular area and designated color information. In step S102, the CPU 201 acquires the color information of the special color gamut (see the first color gamut 312 of the first object image 310 designated by the user in FIG. 10) to be converted into the special color of the object in the rectangular area. The “color information” is color information designated in the object image, and is specifically numerical information of a color in a color space of a format such as RGB, CMYK, LAB, LRV, and HEX of the object image.

In step S104, the CPU 201 confirms whether or not the color information of the special color gamut and the color information of the background color are the same. In a case where the color information are not the same (No), the selection process is ended, and the process proceeds to the print process of printing the special color gamut of the object of the rectangular area selected by the rectangular frame (see the first color gamut 312 of the first object image 310 designated by the user in FIG. 10) by using the special color. In a case where the color information is the same (Yes), the process proceeds to step S106.

In step S106, the CPU 201 displays a message indicating whether or not to set the area to be converted into the special color with the free curve on the liquid crystal display 212 (see FIG. 7).

In step S108, the CPU 201 confirms whether or not to set the area to be converted into the special color with the free curve. In a case of being not set (No), the selection process is ended, and the process proceeds to a print process of printing the special color gamut of the object of the rectangular area selected by the rectangular frame (see the first color gamut 312 of the first object image 310 designated by the user in FIG. 10) and the background color using the special color. In a case of setting with the free curve (Yes), the process proceeds to step S110.

In step S110, the CPU 201 enlarges and displays the rectangular area on the preview screen 240 (see FIG. 7) (see FIG. 11). In step S112, the CPU 201 acquires the area selected with the free curve (see FIG. 11). In step S114, the CPU 201 divides the area selected with the free curve into the micro rectangular areas as a set of the micro rectangular areas (see FIG. 12), ends the selection process, and proceeds to the print process of printing the special color gamut of the object selected with the free curve (see the first color gamut 312 of the first object image 310 designated by the user in FIG. 12) by using the special color.

### Action

Next, the action of the present exemplary embodiment will be described.

In a case where the user selects the first color gamut 312 of the first object image 310 in the preview image 300 of the preview screen 240, the first color gamut 312 of the first object image 310 may be individually printed in silver as an example of the special color.

In addition, even in a case where the first object image 310 and the second object image 320 are present in the rectangular area 352 surrounded by the rectangular frame 350, only the first color gamut 312 of the first object image 310 may be printed in silver.

In addition, in a case where the background color 308 of the rectangular area 352 is the first color gamut 312, the user selects the first object image 310, so that only the first color gamut 312 of the first object image 310 may be printed in silver, which is an example of the special color.

In addition, in a case where the background color 308 of the rectangular area 352 is a special color gamut, a fact that the user selects the first object image 310 is confirmed in advance. Therefore, printing only the first color gamut 312 of the first object image 310 in silver and printing both the background color 308 of the rectangular area 352 and the first color gamut 312 of the first object image 310 in silver may be selected.

Since the user prints the first object image 310 surrounded by the free curve 360 in the preview image 300 of the preview screen 240 in the first color gamut 312 and silver, an area to be printed in silver may be set in detail as compared with a case where the first object image 310 is selected only by the rectangular frame 350.

In addition, since the first color gamut 312 of the first object image 310 surrounded by the free curve 360 is divided into the micro rectangular areas 362 and each micro rectangular area 362 is printed in silver, the first color gamut 312 of the first object image 310 may be separated from the other special color gamut, that is, the background color 308 in the present exemplary embodiment.

### Others

The present invention is not limited to the exemplary embodiments.

For example, in the above exemplary embodiment, the special color gamut (the first color gamut 312 in the above exemplary embodiment) in which the first object image 310 is surrounded by the rectangular frame 350 and then converted into the special color is set. However, the present disclosure is not limited thereto. The numerical value of the colorimetric value of the special color gamut to be converted into the special color may be set in advance, and then the first color gamut 312 having the same colorimetric value of the special color gamut in the rectangular area 352 surrounded by the rectangular frame 350 may be converted into the special color. In this case, a range may be set for the colorimetric value of the special color gamut to be converted into the special color. In this case, in a case where the background color 308 is within the range of the colorimetric value of the special color gamut, a message indicating whether or not to set the area to be converted into the special color with the free curve 360 is displayed on the liquid crystal display 212 (refer to FIGS. 1 and 7) even though the first color gamut 312 and the background color 308 are not exactly the same color.

In addition, for example, in the exemplary embodiment, first, in a case where the first color gamut 312 of the first object image 310 of the rectangular area 352 surrounded by the rectangular frame 350 and the background color 308 have the same color, the first object image 310 is selected by being surrounded with the free curve 360. However, the present disclosure is not limited thereto. Even in a case where the first color gamut 312 and the background color 308 are not the same color, or in a case where the background color 308 is not set, the first object image 310 may be selected by being surrounded with the free curve 360. In this case, for example, even in a case where the first color gamut 312 of the first object image 310 and the third color gamut 322 of the second object image 320 are the same color, only the first color gamut 312 of the first object image 310 can be printed using the special color.

In addition, for example, in the exemplary embodiment, the special color is silver (Si), but the present disclosure is not limited thereto. The special color may be a metallic color other than silver, for example, gold (G). In addition, examples of the special color other than the metallic color include white including pearl white, off-white, cream, and ivory, transparent (clear), fluorescent colors such as fluorescent pink and fluorescent yellow, pastel colors, and the like.

Here, the special color is a color that cannot be expressed by cyan (C), magenta (M), yellow (Y), and black (K), which are three primary colors of the color, or a color that is difficult to express, and is a general term for a color that is premixed other than CMYK. The cyan, magenta, yellow, and black include light cyan, light magenta, light yellow, gray, and the like.

In addition, for example, in the exemplary embodiment, the special color gamut is converted into a special color and printed, but the present disclosure is not limited thereto. The present invention can be applied even in a case where a special color is printed as a base material under the special color gamut. Alternatively, the present invention can be applied even in a case where a special color is printed by being superimposed on a special color gamut. That is, the expression that “the special color gamut is printed by using a special color” includes three cases of converting the special color gamut into a special color and printing the special color, printing the special color as a base material under the special color gamut, and superimposing and printing the special color on the special color gamut.

In addition, for example, in the exemplary embodiment, the setting of the background color and the setting of the special color are performed by the user operating the image forming apparatus 200, but the present disclosure is not limited thereto. The setting of the background color and the setting of the special color may be performed by the image processing apparatus 100.

In addition, for example, the image processing apparatus 100 is a Personal Computer (PC), but the present disclosure is not limited thereto. The image processing apparatus 100 may be a smartphone, a digital camera, a tablet terminal, or the like.

In addition, for example, in the exemplary embodiment, the image processing apparatus 100 includes a printer driver, but the present disclosure is not limited thereto. The present invention can also be applied to so-called direct printing in which a file to be printed is transferred to the image forming apparatus 200 without going through the printer driver and the file itself is recognized and printed.

In addition, for example, in the exemplary embodiment, a printing system of the print engine 208 is an electrophotographic system, but the present disclosure is not limited thereto. The print engine may adopt a printing system other than the electrophotographic system, for example, an ink jet system.

While an aspect in which the program for the image processing is prestored (installed) in the ROM or the storage is described in each of the exemplary embodiment, the present invention is not limited to the aspect. The program may be provided in a form of being recorded on a recording medium such as a compact disk read only memory (CD-ROM), a digital versatile disk read only memory (DVD-ROM), and a universal serial bus (USB) memory. Further, the program may be downloaded from an external device via the network N.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Further, the present invention can be implemented in various ways without departing from the concept of the present invention. A plurality of exemplary embodiments, modification examples, and the like can be combined and implemented as appropriate.

### Supplementary Note

(((1)))

An image forming system comprising:
one or more processors configured to:
   have a mode of executing a process of printing a print image using a special color with respect to a special color gamut of an object image, which is selected by a user, of a preview screen of the print image.
(((2)))

The image forming system according to (((1))), wherein the processor is configured to:
in the mode, execute a process of printing the special color gamut of the selected object image in a rectangular area, which is set by the user, of the preview screen using the special color.
(((3)))

The image forming system according to (((2))), wherein the processor is configured to:
in the mode, in a case where a background color of the rectangular area is the special color gamut of the object image of the rectangular area, enable the user to select the object image.
(((4)))

The image forming system according to (((2))) or (((3))), wherein the processor is configured to:
in the mode, in a case where a background color of the rectangular area is the special color gamut of the object image of the rectangular area, display a confirmation screen for confirming selection of the object image by the user.
(((5))

The image forming system according to any one of (((1))) to ((4)) wherein the processor is configured to:
in the mode, execute a process of printing the special color gamut of the object image, which is surrounded by a free curve by the user, of the preview screen using the special color.
(((6)))

The image forming system according to (((5))), wherein the processor is configured to:
in the mode, execute a process of dividing the special color gamut of the object image surrounded by the free curve into micro rectangular areas, and printing each of the micro rectangular areas using the special color.
(((7)))

An operation reception apparatus comprising:
one or more processors configured to:
   in a case where a background color included in a print image is a special color gamut of an object image in a rectangular area, which is set by a user, of a preview screen of the print image, display a confirmation screen for confirming selection of the object image to be printed using a special color.
(((8)))

A program causing a computer to execute a process comprising:
printing a print image using a special color with respect to a special color gamut of an object image, which is selected by a user, of a preview screen of the print image.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system comprising:
one or more processors configured to:
have a mode of executing a process of printing a print image using a special color with respect to a special color gamut of an object image, which is selected by a user, of a preview screen of the print image.

2. The image forming system according to claim 1, wherein the processor is configured to:
in the mode, execute a process of printing the special color gamut of the selected object image in a rectangular area, which is set by the user, of the preview screen using the special color.

3. The image forming system according to claim 2, wherein the processor is configured to:
in the mode, in a case where a background color of the rectangular area is the special color gamut of the object image of the rectangular area, enable the user to select the object image.

4. The image forming system according to claim 2, wherein the processor is configured to:
in the mode, in a case where a background color of the rectangular area is the special color gamut of the object image of the rectangular area, display a confirmation screen for confirming selection of the object image by the user.

5. The image forming system according to claim 1, wherein the processor is configured to:
in the mode, execute a process of printing the special color gamut of the object image, which is surrounded by a free curve by the user, of the preview screen using the special color.

6. The image forming system according to claim 5, wherein the processor is configured to:
in the mode, execute a process of dividing the special color gamut of the object image surrounded by the free curve into micro rectangular areas, and printing each of the micro rectangular areas using the special color.

7. An operation reception apparatus comprising:
one or more processors configured to:
in a case where a background color included in a print image is a special color gamut of an object image in a rectangular area, which is set by a user, of a preview screen of the print image, display a confirmation screen for confirming selection of the object image to be printed using a special color.

8. A non-transitory computer readable medium storing a program causing a computer to execute a process comprising:
printing a print image using a special color with respect to a special color gamut of an object image, which is selected by a user, of a preview screen of the print image.
